(19) United States
(12) Patent Application Publication
(10) Pub. No.: US 2012/0031852 A1
(43) Pub. Date: Feb. 9, 2012

(54) GRAPHENE BASED ELECTRODES FOR ELECTROCHEMICAL REACTIONS, AND ELECTROOXIDATION PROCESS FOR THE REMOVAL OF CONTAMINANTS FROM LIQUIDS USING SAID ELECTRODES

(75) Inventor: Ivano Aglietto, Torino (IT)

(73) Assignee: SA ENVITECH S.R.L., Cavenago Di Brianza (IT)

(21) Appl. No.: 13/263,293

(22) PCT Filed: Apr. 6, 2010
(86) PCT No.: PCT/EP2010/054552

§ 371 Date: Oct. 6, 2011

(30) Foreign Application Priority Data
Apr. 6, 2009 (IT) MI2009/A000547

(51) Int. Cl. C02F 1/465; H01M 4/583; H01M 4/86; H01B 1/04; C25B 11/12; B82Y 99/00

(52) U.S. Cl. 210/748.09; 252/502; 205/760; 204/294; 204/242; 204/278; 204/277; 429/231.8; 429/523; 977/742; 977/932

(57) ABSTRACT

An electrode is described completely made of graphenes or containing high amounts of these compounds in mixture with nanostructured or non-nanostructured carbon-based materials. An electrooxidation process for the removal of contaminants from liquids, and a reactor for performing the process, based on the use of said electrodes, are also described.

### FIELD OF THE INVENTION

The present invention refers to a new kind of electrodes for use in electrochemical processes, in particular in an advanced electrooxidation process for the removal of organic and inorganic contaminants from contaminated liquids.

### PRIOR ART

Electrochemical reactions have wide application in many industrial processes. Only to name a few, galvanic processes, Dye-Sensitized Solar Cells (DSSCs), electroflotation for wastewater treatment, production and storage of energy in batteries and fuel cells. A particularly important class is that of electrochemical processes directed to purification or remediation of polluted liquids, especially industrial wastes and polluted groundwaters. Given its importance, the rest of the description will be made with reference to this application, but the teachings disclosed herein as to the electrodes have general applicability in the field of electrochemical processes.

The purification of contaminated liquids today constitutes a major problem in the environmental field and the international regulations impose increasingly restrictive concentration limits at the treatment plant outlets, in order to guarantee quality standards suitable for avoiding health risks to humans and the ecosystem. For example, Italian law does not permit discharge into surface water in which the COD is higher than 160 mg/L; COD is the acronym for Chemical Oxygen Demand and indicates the quantity of oxygen necessary for complete oxidation of the organic and inorganic compounds present in a sample of water; this value is therefore an index of the degree of pollution of the water by oxidable substances, mainly organic. In the rest of the description particular reference will be made to water as the liquid to be decontaminated, since it represents by far the most abundant liquid medium in industrial and civil waste, but the teachings of this text can be applied in general also to other liquids.

One of the processes studied for this purpose is the process of electrolysis, often and perhaps more correctly defined as process of electrocoagulation or electrooxidation (the latter term is adopted in the present text). This process uses metallic electrodes immersed in the contaminated liquid (generally water-based) which acts as an electrolyte. The electrodes are commonly made of iron or aluminum. Taking as an example the case in which aluminum electrodes are used, the following reactions develop in the electrolytic cell:

at the anode:

Al→Al³⁺_{(aq)}+3e⁻ (I)

2H₂O₍ₗ₎→4H⁺_{(aq)}+O_{2(g)}+4e⁻ (II)

at the cathode:

4H⁺_{(aq)}+4e⁻→H_{2(g)} (III)

2H₂O₍ₗ₎+2e⁻→H_{2(g)}+2OH⁻_{(aq)} (IV)

and globally:

Al³⁺_{(aq)}+3H₂O₍ₗ₎→Al(OH)₃₍ₛ₎+3H⁺_{(aq)} (V)

or:

Al³⁺_{(aq)}+3OH⁻_{(aq)}→Al(OH)₃₍ₛ₎ (VI)

Al³⁺ and OH⁻ ions generated by the above reactions react with each other and can form different monomer species, such as Al(OH)²⁺, Al(OH)₂⁺, Al₂(OH)₂⁴⁺, Al(OH)₄⁻, or polymer species, such as Al₆(OH)₁₅³⁺, Al₇(OH)₁₇⁴⁺, Al₈(OH)₂₀⁴⁺, Al₁₃O₄(OH)₂₄⁷⁺, Al₁₃(OH)₃₄⁵⁺, which are finally transformed into Al(OH)₃ following complex precipitation kinetics.

For low pH values, the flocculation is manifested in terms of precipitation, whereas for pH values >6.5, it is manifested in terms of adsorption. The amorphous floccules of Al(OH)₃ have a high surface area which lends itself to rapid adsorption of the soluble organic compounds and to trapping of the colloidal particles. The generation of the latter destabilises the contaminants and is followed by an electrophoretic concentration of colloids, generally with negative charge, which are directed towards the anode by the electric field. The particles interact with the aluminum hydroxides and can be removed by both complexation and by electrostatic attraction. The presence of the electric field increases the coagulation phenomena.

The metal aluminum ions (Al³⁺) therefore behave as excellent coagulants, they hydrolyse near the surface of the anode and contribute to destabilising the particles of contaminant which tend to aggregate, forming floccules. At the same time the bubbles of gaseous hydrogen formed at the cathode promote flotation of the floccules which therefore come to the surface. On the bottom of the electrolytic cell are the precipitates, mostly metals, which tend to form a sludgy sediment.

Although potentially of interest for the application, and despite the fact that in recent years the process of electrooxidation has been the subject of various scientific publications and patents, it has not been hugely successful on the market and has not become commercially widespread. The main reasons for this are corrosion of the electrodes which constitute the anode and passivation of the electrodes constituting the cathode, with consequent high costs due to frequent replacement of the electrodes and cleaning thereof, in addition to the production of high quantity of sludge connected with the formation of hydroxides of the metal constituting the anode.

The above problem, which constitutes the limiting factor to an economically interesting application of the technology, occurs whenever a metal is used as the electrode.

### SUMMARY OF THE INVENTION

It is an object of the present invention to provide a new kind of electrodes for electrochemical processes, in particular electrooxidation processes for the removal of contaminants from liquid waste, as well as to provide an electrooxidation process that uses said electrodes.

These objects are achieved according to the present invention, which in a first aspect thereof concerns an electrode made of graphenes, of a mixture of graphenes and other nanostructured carbon-based materials comprising at least 30% by weight of graphenes, or of a mixture of graphenes and other non-nanostructured carbon-based materials comprising at least 80% by weight of graphenes.

### BRIEF DESCRIPTION OF THE FIGURES

The invention will be described below with reference to the Figures, in which:

FIG. 1 shows in detail, schematically, a reactor for performing the process of the invention;

FIG. 2 shows various alternative arrangements of electrodes in the reactor of FIG. 1;

FIG. 3 shows a possible geometric arrangement of electrodes in the reactor;

FIGS. 4 and 5 show construction details of the electrodes of the invention;

FIG. 6 shows a possible alternative construction of the electrooxidation reactor; and

FIG. 7 shows electrodes suitable for use in the reactor of FIG. 6.

### DETAILED DESCRIPTION OF THE INVENTION

In a first aspect, the invention regards a new kind of electrodes for use in electrochemical processes. These electrodes are characterized by comprising at least 30% by weight of graphenes, possibly in mixture with other forms of nanostructured or non-nanostructured carbon-based materials.

In the present text, the terms “nanostructured carbon-based material” or “nanostructured carbon” indicate the various forms of aggregation of carbon in which the element forms discrete mono-, two- or three-dimensional structures, in particular fullerenes, carbon nanotubes, graphite nanoplates, carbon nanofibers, graphenes or their mixtures. These forms of carbon aggregation are known in the sector; briefly, a graphene is one-atom-thick planar sheet of sp²-bonded carbon atoms that are densely packed in a honeycomb crystal lattice; fullerenes are essentially spherical hollow structures, formed of carbon atoms arranged at the vertexes of regular or almost regular polyhedrons; nanotubes (known also as CNTs) are hollow structures of indefinite length, formed of carbon atoms which are arranged on cylindrical surfaces (one single surface in the case of single-wall nanotubes, forming nanotubes known in the sector under the acronym SWNT, or several concentric walls, forming nanotubes known as MWNT); graphite nanoplates are pieces of graphite with a thickness of a few nanometers; and carbon nanofibers are cylindrical nanostructures with graphene layers arranged as stacked cones, plates or cups.

All these structures are characterized by the fact that their maximum dimensions are in the order of tens of micrometers (except for the fullerenes, which have dimensions in the order of tens of nanometers), and therefore they have very high specific surfaces (surface per unit of weight of material), which give them particular chemical-physical properties. Furthermore, they present high conductivity and low resistivity so that they are very useful for such kind of application.

Still in the present text, by “non-nanostructured carbon-based materials” are meant forms of carbon not characterized by nanometric dimensional features, such as expanded graphite or other graphite and carbon-based compounds.

The inventor has found that the best electrodes for electrochemical reactions are those made of pure graphene layers, or of mixtures of graphenes with other forms of carbon (either nanostructured or non-nanostructured) with high concentration of graphene sheets. For instance, in the case of electrooxidation processes, these electrodes have shown an efficiency in terms of contaminant removal about 3 times higher if compared with electrodes made of carbon-based nanostructured materials, in particular nanotubes, fullerenes or mixtures of these or with other such nanostructured materials; the difference in efficiency is even more marked with respect to non-nanostructured carbon based materials. This is due to the higher specific surface area and lower resistivity of graphenes; in fact, graphene is an intrinsic semi-metal or zero-gap semiconductor. In this case there is a higher production of ozone and hydrogen and the current necessary for the electrooxidation treatment is lower with economical benefit. Fore these reasons, the electrodes of the invention, when made with a mixture of different forms of carbon-based nanostructured materials, must contain graphenes in a weight concentration of at least 30%; while, when made with a mixture of graphenes and non-nanostructured carbon-based materials, must contain graphenes in a weight concentration of at least 80%.

In the following parts of this text, for the sake of simplicity, the materials for the production of electrodes according to the invention will be referred to cumulatively with the definition “graphene-containing”, by which will be meant pure graphenes or a mixture of graphenes with other forms of nanostructured or non-nanostructured carbon-based materials. Besides, physical and chemical modifications of the base nanostructured carbon materials can be used as well in the electrodes of the present invention, such as graphene oxide or graphane (hydrogenation of graphene); the definition “graphenes” will be intended in the rest of the text to comprise these chemically modified forms of nanostructured carbon as well.

Given the advantages afforded by graphenes over the other forms of carbon-based nanostructured materials, in case of electrodes produced with mixtures of nanostructured carbon-based materials, it is preferable that the nanostructured material used for producing the electrodes of the invention contain an amount as high as possible of this particular form of nanostructured carbon, preferably above 60% and even up to 100% by weight (pure graphenes); however, as in some instances (mostly depending on the preparation process) it may be difficult to separate the graphene component from the other forms of nanostructured carbon, for practical applications it may be acceptable a nanostructured carbon material containing up to 90% by weight of graphenes.

An example of commercial nanostructured carbon product with high concentration of graphene available in the market with production of industrial quantities is RECAM®, (REactive CArbon Material), a highly reactive and crystalline nanostructured material made from a mixture of graphene sheets, graphite nanoplates, carbon nanofibers and carbon nanotubes, produced and sold by the Applicant. In case of the use of this particular commercial material, the inventor has verified that the efficiency of the electrooxidation, in terms of contaminant removal, is higher in case RECAM® is compressed with pressure values higher then 300 kg/cm².

As stated above, in case of electrodes comprising non-nanostructured carbon-based materials, the content of graphenes must be higher than 80% by weight.

All these electrodes can be produced using graphenes as they are or by subjecting them to a high compression to form a compact structure.

In a second aspect, the invention is about an electrooxidation process for removal of contaminants from liquids that uses the electrodes described above. In this process, the electrodes of the invention must be used as anodes, but they could be used to form both the anodes and the cathodes, as described below.

The inventor has surprisingly found that the use of anodes made of graphene-containing materials in electrooxidation processes for the treatment of contaminated liquids avoids both the problem of wear of the anodes and the consequent formation of sludge, which has so far hindered the spread of the technique. The cathodes can be made of traditional materials, for example iron or aluminum, or can in turn be made of the same material as used for production of the anodes. In the latter case the process is improved since there is an increased production of gaseous hydrogen at the cathode, the problems of passivation are greatly reduced and the anode can be inverted with the cathode without problems of corrosion at the anode.

In the process, the anodes obtained by compression have the following properties:

high electrical conductivity;

high production of H₂, with a volume percentage in the gas usually in the range of 15-35%;

ozone production during the process that enhance the process of chemical oxidation;

they limit the pH variations during the process;

they function as catalysts for the entire process: no electrode corrosion process occurs at the anode;

they constitute the absorbent and reagent medium in terms of surface;

they facilitate removal of COD, BOD₅, heavy metals, chromium, boron, nitrogen containing compounds and ammonia;

no sludge or sediments form in the process cell;

formation of products with high oxidising power.

The process of the invention and the way in which use of the anodes described above permits a process of electrooxidation with improved characteristics with respect to analogous known processes are described below.

The process of the invention takes place under direct current. As is known, electrooxidation for the decontamination of liquids is governed by the laws of Faraday, which can be summarised by the following formula:

$$m = \frac{Q \cdot M}{z \cdot F}$$

in which:

m=mass of substance produced at the electrode;
Q=total charge passed through the solution;
z=valence number of the ions of the substance (no. of electrons transferred per ion);
M=molecular mass of the substance;
F=Faraday constant=96,485 C/mol.

The total charge Q is given by the integral of the electric current I on the time t, for the total time T of the electrolysis process; if the electrolysis current is constant, the following is obtained:

$$n = \frac{I \cdot T}{z \cdot F}$$

in which:

n=number of moles of substance produced=m/M
T=total time in which the constant current I is applied.

The quantity of substance produced in the electrooxidation (i.e. of ions reacted and then removed) is thus directly proportional to the current which passes through the system. The processes of electrooxidation are all the more efficient the more current circulates in the system, given the same applied voltage. To maintain a certain amperage with a lower voltage, a larger electrode surface must be used, given the same power. A fairly broad electrode surface is therefore required, while guaranteeing a correct balance with the need for stability of the same. It is important to note that the voltage applied to the system is the input voltage, but the amperage is distributed over the electrode surface. The anodes used in the process of the invention guarantee a very high surface area, and therefore a more effective use of the current.

An increase in the voltage required during the treatment may indicate an increasing covering of the cathode surface. Once the voltage has been defined, the resistance between the electrodes and the water determines the current that flows.

The current intensity applied influences the effectiveness of the treatment, especially in the first few minutes of reaction. Clearly, it also constitutes a primary cost item of the process. As the current intensity increases, the bubbles that form at the cathode increase in number and diminish in size, with consequent improved effectiveness of the process. The correct amperage and voltage values depend on the type of liquid to be purified.

The instantaneous efficiency is maximum for very low applied current values. By increasing the current intensity, the instantaneous efficiency diminishes since, although the contaminant removal yield increases, the energy consumption increases.

The right balance therefore has to be found between current consumption and contaminant removal efficiency. The process in question features a mechanism for automatic adjustment of the current intensity according to the concentration of incoming contaminant and its removal pattern over time. These adjustments are described below, with reference to the equipment that performs the process. By way of indication, an interval between 10 and 70 mA/cm² of electrode can be assumed as amperage value and an interval between 2 and 15 V as the voltage.

The electrical characteristics of the system and in short its contaminant conversion efficiency also depend on the conductivity of the liquid phase treated. In the presence of high electrical conductivity values, the energy consumption is lower. The cell voltage decreases as the conductivity values increase, given the same applied current intensity: when the conductivity increases, the resistance in the solution drops, and therefore the voltage necessary to maintain the required amperage drops.

Conductivity determines the surface of the electrodes which must be in contact with the liquid to guarantee the minimum voltage necessary for the reaction to occur. Theoretically, as a result of the electrolysis process, the conductivity should diminish during the process. In reality, unlike what happens with the known metallic anodes, in the process of the present invention a stable conductivity value is found in the majority of cases, and in some cases an increase in said value due to the concentration of salts.

Where the electrical conductivity of the liquid to be treated is too low, a dose of sodium chloride or sodium sulphate is added to guarantee the minimum values necessary for efficient treatment. In this case the sodium salt acts as a support electrolyte. By increasing the concentration of sodium salts, the electrical conductivity value increases, which in the end facilitates the passage of current.

The increase in efficiency resulting from a high electrical conductivity value allows a parallel decrease in the energy consumption, which from experimental observations made by the inventor can even be in the order of 70%.

The addition of ions to regulate the saline environment of the system must be performed within certain limits and paying attention to the chemistry of the same. For example, the addition of an excess of SO₄²⁻ ions, which interact with the hydroxyl ions in the presence of high concentrations of salts, can lead to a reduction in removal efficiency. Furthermore, the presence of excessive quantities of carbonate and sulphate ions in the liquid to be treated leads to the precipitation of calcium and magnesium salts which significantly contribute to formation of the insulating layer on the surface of the electrodes, increasing energy consumption. In this case the addition of sodium chloride in a concentration of 1-2 g/l can limit the problem as it releases chlorine.

The pH is the parameter that has the greatest influence in terms of chemical reaction efficiency on the entire process. Unlike what happens with the known metallic anodes, which form hydroxides during the process and therefore lead to a drift in the pH over time (at least until a constant value is reached, characteristic of the system chemistry), with the anodes of the invention, pH remains practically constant during the treatment and in many cases decreases during the treatment. The slight increase in the pH value which is sometimes recorded during the treatment is due solely to the high quantity release of gaseous hydrogen to the cathode.

The ideal pH value for the treatment process depends strongly on the liquid to be treated: in some cases it may be necessary to acidify the wastewater. For example, generally in liquids with high COD values it is preferable to perform the process with acid pH, usually in the range of 4.0÷6.0, whereas in the case of a hydrocarbon contamination or other contaminants like for example boron, the process functions better in a basic environment.

Another important parameter which regulates the effectiveness of the process of the invention is the speed (and modality) of flow of the liquid to be treated (electrolyte) which crosses the electrodes. Preferably, the process of the invention is performed so that liquid is conveyed parallel to the surface of the electrodes, following an undulating path, thus facilitating transport and removal of the gases from the solution, as well as flotation of the floccules. The process can be performed by treating discrete quantities of liquid or in continuous mode, and in both cases with or without recirculation. In a preferred operating mode, to ensure a sufficient reaction time, simultaneously maintaining a dynamic flow condition, a continuous recirculation system is created for a certain period of time; the reaction kinetics are faster in the case of the continuous process.

As said, a further advantage offered by the use of nanostructured carbon anodes with presence of graphene, is the formation of oxidising species. At these anodes the above reaction (II) occurs. The cathodic conversion of the oxygen molecule can be written as:

4H₂O+2O_{2(aq)}+4e⁻→2H₂O₂+4OH⁻ (VII)

4H⁺_{(aq)}+4e⁻→H_{2(g)} (VIII)

2H₂O₍ₗ₎+2e⁻→H_{2(g)}+2OH⁻_{(aq)} (IX)

Furthermore, when the anode voltage exceeds 1.51 V, ozone is produced:

H₂O+O_{2(aq)}→O₃+2H⁺+2e⁻ (X)

During the process various oxidising agents are therefore generated such as oxygen, ozone, hydrogen peroxide, free chlorine and free radicals such as ClO., Cl. and OH..

The dissolved oxygen diminishes as the voltage used increases since the liquid becomes progressively more reducing. During the process the waste to be treated is maintained constantly oxygenated. The oxygenation and possible agitation of the liquid has the following benefits:

increases removal of the ammonia if present as it facilitates the stripping action in a basic environment;

facilitates cleaning of the electrodes and reduces the problem of fouling of the cathode;

facilitates the phenomena of coagulation and flocculation; guarantees the presence of oxidising agents;

operating in continuous mode, the ions produced are in continuous movement and the gases that form are removed, which in turn facilitate flotation.

The oxidising agent that plays the main role in the process with this type of electrodes is the hydrogen peroxide and hypochlorite if the initial liquid contains a significant concentration of chlorides.

In application to wastes with a high concentration of chlorides, the following reactions take place:

2Cl⁻→Cl₂+2e⁻ (XI)

Cl₂+H₂O HOCl+H⁺+Cl⁻ (XII)

Chlorine molecules are therefore generated and then hydrolysed. The above reactions contribute positively to the treatment process as hypochlorous acid and hypochlorite ions have a high oxidising power. The presence of chloride ions in the waste to be treated should therefore be considered positive for the efficiency of the treatment. Furthermore, if the concentration of gaseous chlorine is higher than its solubility in water, bubbles form which can aid flocculation.

The process is also particularly effective for removal of nitrogenous compounds and ammonia. The reduction of the nitrates is governed by the following reactions:

NO₃⁻+3 H₂O+5e⁻→0.5N₂+6OH⁻ (XIII)

NO₃⁻+6 H₂O+8e⁻→NH₃+9OH⁻ (XIV)

The direct and indirect oxidation of ammonia in the presence of OH⁻ and Cl⁻ occurs with the reactions:

2NH₃+6OH⁻→N₂+6H₂O+6e⁻ (XV)

2NH₃+6Cl⁻→N₂+6HCl+6e⁻ (XVI)

The temperature increases as an effect of the oxidation-reduction reactions and as the current intensity increases. The process is constantly monitored by thermocouples and the increase in temperature with respect to its intake value varies in a range between 5 and 40° C. according to the type and concentration of the contaminants to be treated.

Lastly, it is preferable to apply magnetic fields to the fluid being treated, especially if it is water-based. Water is known to be a universal solvent, able to dissolve the majority of inorganic substances and many of the organic substances with which it comes into contact. The positive portion of the water molecule attracts the negative particles or the negative part of the polar particles and vice versa the negative part of the water molecule. It has been demonstrated that the presence of an external magnetic field modifies some properties of water, such as its viscosity and vaporisation rate. The structural changes of the water molecule are essentially associated with a greater force of the hydrogen atom bonds. The application of magnetic fields to the fluid being treated increases the process yield in terms of efficiency and energy saving.

In a preferred embodiment, the process of electrooxidation is associated with a newly conceived photocatalytic process. The inventor has found that a photocatalytic system consisting of a combination of titanium dioxide and graphenes in contact with each other presents improved functional properties with respect to the traditional photocatalytic systems based on the use of titanium dioxide only.

The titanium dioxide is preferably anatase, but rutile can also be used (or a mixture of the two forms). The titanium dioxide can be used both in the form of powder or granules (better known in the sector as pellets), and in the form of a film of the material, mainly in the anatase form, deposited with graphene-containing materials on different types of surfaces or directly on surfaces containing a reasonable concentration of said graphenes.

If titanium dioxide is used in the form of pellets, the reaction kinetics are slower and therefore longer treatment times are required. On the other hand the problem of removal of the titanium dioxide from the purified liquid, downstream of the process, is practically eliminated.

The problem of separation of anatase nanoparticles from the liquid after treatment is solved when titanium dioxide is coupled with graphene-containing materials. In fact graphenes are well known to be high hydrophobic and very light so that the separation after treatment is possible and easy with a simple flotation process.

Graphenes can be coupled with the titanium dioxide using graphene sheets directly or using graphene-containing materials, like for example RECAM®, which contain at least a concentration of graphene sheets of no less than 30% in weight.

If titanium dioxide is used in granule or pellet form, these particles are coupled with graphene which adhere to the surface of the titanium dioxide, forming one single structure. In this way, maximum exposure of the TiO₂ is obtained, optimising the process yields.

The fact that aqueous solutions (the most interesting solutions to treat, since they are by far the most abundant form of liquid residues to be decontaminated) can be made to coexist and intimately mixed with graphenes, well-known to be hydrophobic, is due to a phenomenon that occurs on the surface of TiO₂ following absorption of light radiation (mainly UV, but also low wavelength visible light in the case of anatase), which makes parts of the surface of the titanium dioxide extremely hydrophilic (with very low water contact angles, <1°), while other parts of the same surface remain hydrophobic. In this way, the TiO₂ allows the coexistence of hydrophilic and hydrophobic phases, therefore giving rise to optimal coupling, in terms of stability in solution, of the titanium dioxide with hydrophobic materials that contain a high percentage of graphenes.

The inventor has observed that the coupling of TiO₂ with graphenes considerably improves the properties of the first material, because the electrons which are released following activation by means of illumination are easily transferred and transported into the graphene sheets. It follows that the possibility of recombination of the pairs consisting of an electron in the conduction band and an electron hole in the valence band of the material is greatly reduced, increasing the yield of the process.

Furthermore, the combination of graphene-containing materials with TiO₂ increases the absorption threshold from 3.18 (in the case of anatase) to 3.54 eV, with an increase in the oxidising capacity of the photocatalyst.

The percentage by weight of the graphenes which must be present in the mixture depends on the form in which it is present in titanium dioxide. If titanium dioxide is used in the form of nanoparticles, the weight ratio between titanium dioxide and graphene-containing material can vary between approximately 10:1 and 1:1 (preferably approximately 5:1), while said ratio can vary between approximately 20:1 and 10:1 (preferably approximately 15:1) in the case of titanium dioxide in granules or pellets.

The radiation used to activate TiO₂ can have wavelength in the ultraviolet (UV-A, UV-B or UV-C) or also in the visible spectrum; in fact, while the TiO₂ used alone has a maximum absorption efficiency at a wavelength of 364 nm (UV-A region), the coupling with graphene widens the spectrum of absorbable radiations so that the process is also activated in the visible region at a wavelength of approximately 410 nm.

The process works with TiO₂/graphenes combination quantities that can vary within very broad intervals; in principle, any quantity of said combination in a liquid to be treated gives rise to the desired effects. To obtain an efficient process, however, said quantity must be within an optimal interval. In fact, if the TiO₂/graphenes combination is present in too low a quantity, the efficiency of the process is clearly reduced, while if said quantity is too high, the liquid is very turbid, thus limiting the passage of the radiation with the effect of diffusion of the luminous beam and poor irradiation of the particles farthest from the surface of the liquid, which also in this case leads to reduced efficiency. In the context of the present process, the optimal quantities of titanium dioxide and graphenes which are used for the photocatalytic process are correlated with the type of contaminants to be treated. On the basis of the pilot scale treatments performed, it was determined that the concentration in granules of titanium dioxide can vary in most cases in an interval between 0.1 and 2.3 g/litre, according to the type of contaminants to be removed from the contaminated liquid and the chemical characteristics of the same, while the quantity of graphene-containing material is derived from the quantity of TiO₂. Said values will certainly be higher if titanium dioxide in pellet form is used. Furthermore, in the case of the use of titanium dioxide in terms of thin film, the reference datum is not the quantity of titanium dioxide in the liquid to be treated, but the surface of the film to the radiation.

Another parameter which significantly affects the yield of the photocatalytic process is the pH of the liquid treated.

In an acid environment the TiO₂ surfaces are positively charged and absorption of the negatively charged contaminants is favoured, vice versa in a basic environment, absorption of the positive ions is favoured. Furthermore, in an acid environment the risk of the formation of carbonates following the formation of carbon dioxide during the process is reduced. This aspect is important as the carbonates exert a negative action vis-à-vis the titanium dioxide and therefore their formation should be avoided.

The titanium dioxide has a null charge at pH 6.5, therefore slightly acid or near-neutral conditions are the least suitable for treatment of the majority of contaminated liquids.

The temperature during the process increases as a result of the oxidation-reduction reactions and, in the case of the use of UV lamps, in particular due to the heating induced by radiation of the latter. The increase in the temperature values recorded during the treatment is in the order of 5-25° C. and does not affect the efficiency of the treatment; in fact the titanium dioxide maintains its photocatalytic properties virtually unchanged up to approximately 900° C.

The radiation time during the process varies from a minimum of 10 minutes to a maximum of two hours, according to the type of contaminants to be removed and the quality objectives of the water at discharge.

Hydrogen peroxide can be added to the liquid to be treated; it has been shown that said substance is able to increase the degradation of the contaminants and speed up the reaction kinetics via mechanisms triggered by the presence of electrons on the surface of titanium dioxide, due to UV or visible radiation. Usually the concentration of hydrogen peroxide (30% concentration) can be in the range of 0.2÷1,5 mg/l.

In the process of the invention, oxygen is furthermore preferably added to the liquid containing the contaminants during the treatment, preferably in the form of microbubbles or nano bubbles in order to increase the specific contact surface. The presence of oxygen greatly increases the efficiency of the photocatalytic reactions. The addition of oxygen is important because, when absorbed on the surface of TiO₂, it reacts with the e⁻_{CB} forming the superoxide radical O₂.⁻, which in turn is a strong oxidant of the contaminating species. It is preferably to ad oxygen in the form of micro or nano bubbles, to increase the surface area.

According to this preferred mode, electrooxidation improves the transparency of the liquid to be treated, allowing the UV or visible radiation to better reach the particles of TiO₂ in contact with graphene, while the photocatalytic system permits more effective and rapid degradation of the residual contaminants of the electrooxidation process. For said purpose, the integrated electrooxidation and photocatalysis process can occur by performing the two subprocesses together or in sequence, first the electrooxidation and then the photocatalysis, as described in further detail below with reference to the reactor (or reactors) in which these processes are performed.

In the following, a possible reactor for carrying out the electrooxidation process of the invention is described.

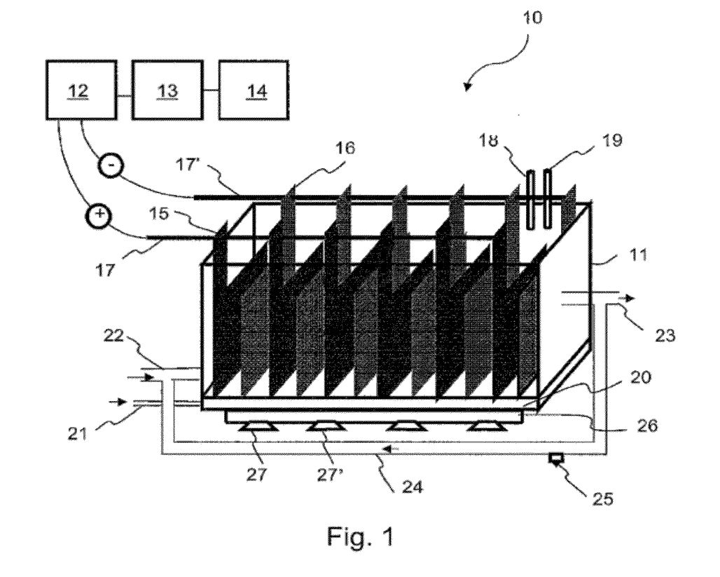

With reference to FIG. 1, the electrooxidation reactor 10 comprises at least one tank for receiving the liquid to be treated, pipes, pumps and valves to control and regulate the incoming flow and pump it to the reactor. The liquid to be treated follows the direction indicated by the arrows, entering the reactor from the left of the drawing and leaving it at the end of the treatment from the right-hand side of the drawing.

The reactor, 10, consists of a cell, 11, the walls of which can be made of different materials, but in any case such as to be compatible with the liquid to be treated each time (for example polypropylene). The forms and the dimension of the cell can be of different type, usually in the form of a parallelepiped; in the figure the cell is seen in section in order to show the elements inside it.

The cell 11 contains at least one anode 15 and one cathode 16, but there are generally an anodic system and a cathodic system each consisting of several electrodes, arranged in the cell 11 in various possible ways as discussed in detail below; since the commonest configuration is the one in which there are several anode electrodes and several cathode electrodes, the following description will refer to this condition.

The reactor 10 is powered in direct current by a current rectifier 12 which is provided with a transformer 13 and an autotransformer (Variac) 14. The rectifier powers the reactor 10 with pre-set voltage and amperage. The system is furthermore provided with a modular electronic rectifier with polarity inversion. The rectifier 12 powers the electrodes which constitute the anode 15 and the cathode 16 of the system via bars of conducting material, 17 and 17′, which are commonly made of copper but can also be made of other materials, for example even gold or silver. The electrodes are arranged in parallel inside the cell 11 and can be positioned at the same height or at staggered heights so as to constitute an undulating path through which the liquid to be treated must flow. With reference to FIG. 2 three possible configurations can be distinguished:

(a) monopolar electrodes in parallel connections;

(b) monopolar electrodes in serial connection;

(c) bipolar electrodes in serial connection.

Case (a) requires a low potential difference with respect to the serial connections. Configuration (b) requires a high potential difference while (c) is the simplest case, in which bipolar “neutral” electrodes are interposed with the unipolar electrodes.

The number of “neutral” electrodes to be inserted between the anode and the cathode depends on the voltage available. By increasing the voltage, therefore, the number of neutral electrodes can be increased. Construction of the reactor must take account of the fact that the neutral electrodes must be slightly thicker than the charged electrodes, to avoid the risk of the electric current by-passing them.

The number of electrodes present in the cell, their thickness and the distance between one electrode and another can vary depending on the type of liquid to be treated and the flow rates through the cell. The nearer the electrodes to one another, the greater the contact/exchange surface per unit of volume and therefore the less the voltage required. In fact, as the distance increases, the energy requirement for carrying the electric current (transported by the ions) through the contaminated liquid increases. The increase in the distance increases the electrical resistance and therefore given the same current intensity, the voltage has to be increased (Ohm's law). However, it should be noted that below 3 mm there is the risk of clogging due to the fact that on the surface of the electrodes a patina of deposited material forms (especially at the cathode) which obstructs the passage of the floccules; vice versa, with distances between the electrodes greater than approximately 12 mm the energy consumption of the system becomes excessive; consequently, the reactor 10 has a centre distance between the electrodes which is optimised each time according to the type of contaminants to be removed and is in the majority of cases between 3 and 12 mm.

Analogous considerations apply to the thickness of the electrodes. The electrodes should, however, be of equal dimensions and parallel in order to limit the required power consumption.

The arrangement of the electrodes in the reactor 10 can differ according to the liquid to be treated. The electrooxidation system is in fact configured by means of a purposely studied process which alternates the various configurations according to a timing which depends on the type of liquid to be treated.

The cell 11 is provided with one or more vent systems 18 and an inlet 19 inside which multiparametric probes can be positioned for the determination of certain chemical-physical parameters (e.g. redox potential, electrical conductivity, dissolved oxygen, pH) or other parameters such as the level of the liquid inside the cell with appropriate level probe. One or more of these probes can be connected by means of a feedback system to the assembly consisting of current rectifier 12, transformer 13 and Variac 14, for continuous adjustment and optimisation of the current intensity supplied to the reactor 10 according to the chemical properties of the liquid to be treated; for example, parameters on which it is possible to base the feedback mechanism are the pH and/or the electrical conductivity of the liquid in the reactor. The cell is furthermore provided with an aeration and oxygenation system with the inlet of micro or nano bubbles. For said purpose a chamber 20 with microslits can be added on the bottom of the cell; the oxygen enters the chamber from a dedicated pipe 21.

The cell 11 and therefore the parallel electrodes contained in it can be arranged either parallel or perpendicular to the direction of the flow. However, a perpendicular arrangement with respect to the flow inlet direction is preferable in order to reduce the accumulation of bubbles on the surface of the electrodes, for example by making the liquid follow an undulating path.

The electrooxidation reactor 10 can operate both for discrete quantities of fluid (batch mode) and in continuous mode, with or without recirculation. In both continuous and batch mode, the liquid enters the cell through a dedicated pipe 22 and leaves via the pipe 23. In the case of recirculation, the liquid is sent back into the cell for a number n of cycles, configuring the pipe 23 so as to send the flow back through the dedicated pipe 24 (this can be done for example by providing a three-way valve, not shown in the figure, at the branching point of the pipe 23; by operating the valve at the desired times, it is possible to send the flow coming out of the cell 11 alternatively to the reactor discharge or again to the reactor inlet through the pipe 24). The cell 11 can be provided with one or more draw-off points for the liquid, 25, and an agitation and/or rotation system 26 installed on the cell.

Lastly, for use in the preferred process mode described above, the cell 11 is preferably equipped with magnets 27, 27′, . . . , shown in the figure on the bottom but which could also be on the walls of the cell, to guarantee a constant magnetic field during the treatment.

The cell 11 can be closed, with the liquid flowing inside it under pressure, or open, with the liquid forming a free surface.

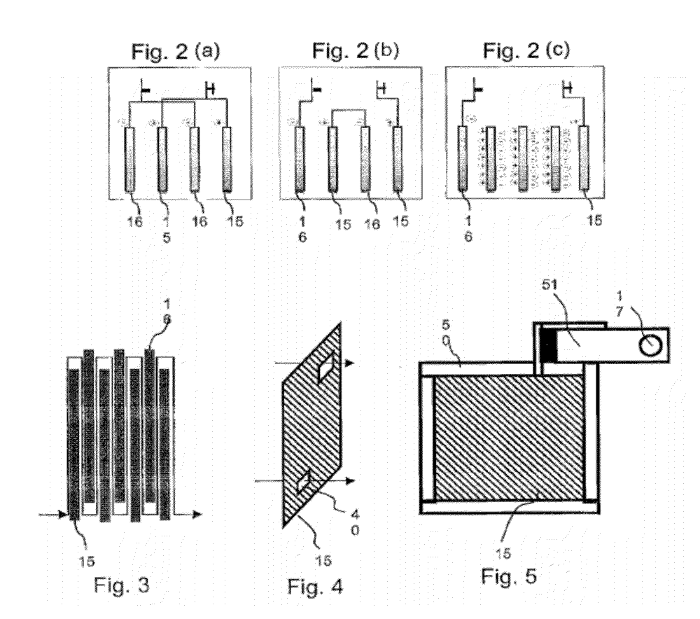

With reference to FIG. 3, the electrodes can be inserted inside the cell by simply positioning them in appropriate grooves, at the same height or at alternating heights, in the latter case creating an undulating path for the liquid, or preferably with an appropriate containment structure made of non-conducting material (for example polypropylene) constituting a single seal pack, with undulating path.

FIG. 4 shows a possible geometry of an electrode according to the invention (the example concerns an electrode with anodic function, 15, but the same geometry can be used also for electrodes with cathodic function). This electrode can be provided with appropriate holes 40 through which the liquid flows, thus favouring electrodes cleaning. There can be more than one hole for each electrode and they can be of different dimensions; however, it should be noted that an excessive number of holes can affect the stability of the nanostructured material used for the anodes.

FIG. 5 shows in detail a possible way of fixing an electrode inside the cell 11. The electrode (also in this case the example concerns an electrode with anodic function, 15, but what is said applies equally to an electrode with cathodic function) is fixed in a frame 50, which can have different forms and dimensions with geometries such as to create turbulence in the liquid flow. The connection with the electrically charged bar 17 is made by means of appropriate metallic connectors 51, generally made of copper, but which can be also be made of other conducting materials.

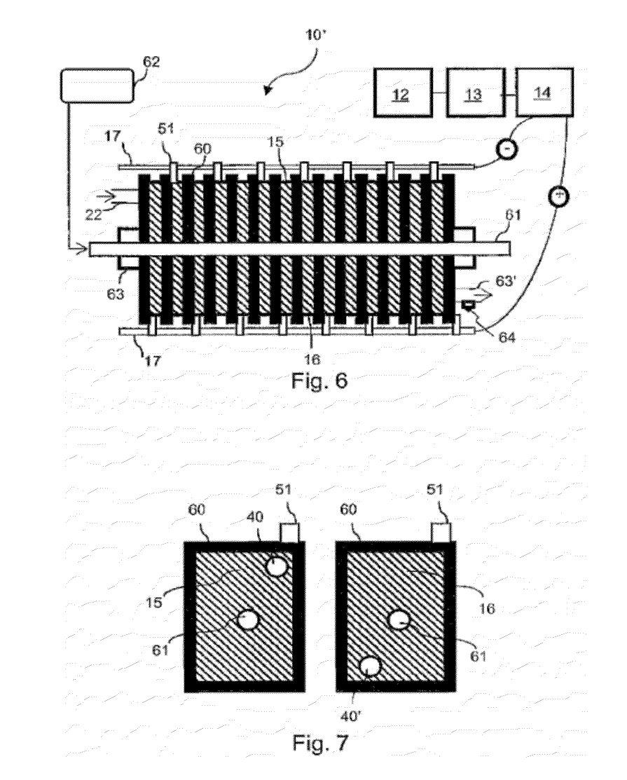

As an evolution of the above technical specifications, optimisation can be achieved with a device shown in FIG. 6, while FIG. 7 shows construction details of the electrodes of the device of FIG. 6. Compared to the configuration of FIG. 1, in this device the electrodes are not inserted in any containment cell (11 in FIG. 1) but arranged in series, separated from one another simply by a gasket 60. The latter is hollow and simply follows the edge of each electrode in order to contain outflow of the liquid and to space the electrodes. The gasket must be made of a material which is chemically stable vis-à-vis the liquid to be treated. The entire electrode/gasket pack created is held by a central shaft 61 and is “contained” by a piston system 62. The central shaft, on which all the electrodes pivot, can be produced with a hollow tube having as surface a membrane diffuser: the oxygen enters the shaft via 22 and can be radially supplied in the form of micro or nano bubbles along all the electrodes. The advantage is twofold: on the one hand a uniform and constant oxygenation of the fluid is guaranteed and on the other, constant cleaning of the electrodes is ensured.

The “pack” of electrodes is held together under pressure by means of two devices 63 and 63′ which block all the electrodes with a system which must be sealed and pressurised.

The liquid to be treated enters via 22 and leaves from 64. The electrodes are provided with holes or slits 40 and 40′ (FIG. 7) arranged in a mirror image on all the electrodes in an alternating manner, so that the liquid enters via one slit, runs over the whole surface of the electrodes and leaves from the opposite slit. In this way the liquid crosses all the electrodes following an undulating path, also facilitating cleaning of the same. The form and the geometry of the points the liquid passes through can be different and there can be more than one point for each electrode, with the sole aim of guaranteeing the undulating path. The geometry of the electrodes can also be of different types, depending on the inlet flow rates of the liquid to be treated, taking care to ensure that the geometries used do not affect the stability of the electrode structure.

The device of FIG. 6 must be provided with a supporting frame, a magnet hooking system and all other equipment necessary and previously indicated for correct functioning of the process.

As said previously, in a preferred embodiment, the electrooxidation reactor is combined with a photocatalytic reactor containing a photocatalytic system consisting of a combination of titanium dioxide and graphenes in contact with each other. The photocatalytic reactor could, in principle, function also with natural radiation but this would not be particularly useful in industrial terms, as the process could be performed only by day, in favourable climatic conditions and outdoors and would in any case require excessively long process times in the majority of cases. For industrial purposes it is therefore necessary to be free of these conditions, and be able to operate the process at any time and in any environment. For this purpose, the photocatalytic reactor can be provided with UV radiation sources (lamps).

The walls of the photcatalytic reactor can be made of different materials, but they must be compatible with the degree of chemical aggressiveness of the contaminants to be treated and resistant to the wavelength spectrum emitted by the reactor lamps. The inner surface of the walls can also be covered of a material or of a film reflecting the wavelength emitted by the lamps in order to optimise the process yield.

The photocatalytic reactor is equipped with at least one set of UV lamps (or lamps with visible light in the blue or violet field) at low or high pressure, for emission of the photons for activating the particles of titanium dioxide and graphenes. The lamps can have emissions with different wavelengths, generally a range between 300 and 420 nm is the most suitable. The number, the geometry, the centre distance and the construction type of the lamps can vary according to the geometry of the photocatalytic reactor. The lamps are protected by tubes made of quartz or other transparent material at the above-mentioned wavelengths. All the lamps are furthermore connected to a power, ignition and intensity regulation system. The photocatalytic reactor is furthermore provided with a vent system with attached filter, if necessary, for treatment of the outflowing gases.

The titanium dioxide with graphenes is preferably used inside the reactor in the form of powder, also in the form of nanoparticles, or pellets, which are dosed in the mixture to be treated by means of an appropriate measuring device. The choice of the morphology of the photocatalytic material depends mainly on the flow rates of liquid to be treated and the type and concentrations of contaminants present in them.

Alternatively the present invention has the same validity, but lower process yield, if the titanium dioxide, mainly in the anatase form coupled with graphenes, is used in the form of thin film. In this case the TiO₂ can be used by depositing it mixed with the graphenes on appropriate surfaces which are arranged inside the photocatalytic reactor. TiO₂ can also be deposited on films of nanostructured materials with sufficient percentages of graphenes, arranged inside the reactor.

The inventor has verified that the most interest results in terms of efficiency of the photodegradation can be achieved in case the anatase is deposited on the graphenes. For this purpose different technologies and processes are available: spray coating, sol-gel, ink-jet deposition, spin coating.

Since, as said in the process description, this has a higher efficiency if the liquid is oxygenated during the treatment, continuous oxygenation is scheduled in the reactor in which the process takes place. For said purpose the usual oxygenation systems sold on the market can be used. For this treatment, a system with membrane diffusers with formation of microbubbles and nanobubbles, the number, geometry and correct arrangement of which depend on the geometry of the reactor, has proved to be particularly effective.

Lastly, if the TiO₂/graphenes combination is used in the form of powder and/or pellets, it may be useful to have a constant dispersion of said powder in the liquid to be treated. For said purpose, the photocatalytic reactor can be equipped with any continuous mixing system on the market, for example a set of Venturi ejectors, the number and correct arrangement of which depends on the geometry of the reactor, according to principles well known to persons skilled in the art.

The electrooxidation and photocatalytic reactors can be combined in two main ways.

The two reactors can be combined by inserting both the electrooxidation electrodes and the TiO₂/graphenes photocatalytic material and the necessary lamps, described previously, inside the same reaction chamber. This method is preferable in terms of compactness but imposes more geometrical and construction material constraints on the reactor, because it must be able to withstand the conditions of both the electrooxidation and photocatalytic process.

Alternatively, the two reactors can be arranged in series, with the photocatalytic reactor preferably downstream of the electrooxidation reactor, after clarification of the liquid coming out of electrooxidation. In this way, the electrooxidation reactor acts as a “preconditioner” of the liquid for the photocatalytic treatment, removing a large part of the contaminants and sending to the photocatalytic process a liquid which is already partly clean, and therefore also more transparent and more suitable for being crossed completely by the UV or visible radiation.

The electrooxidation reactor, or the combined electrooxidation/photocatalysis reactor, or the assembly consisting of electrooxidation reactor and photocatalytic reactor in series can be used in combination with units for pre- or post-treatment of liquids, to form a liquid treatment plant, according to methods known in the sector.

For example, upstream of the reactors of the invention a pre-treatment and conditioning unit may be provided, in which the liquid to be treated in the reactor is filtered to remove coarse particles and any undesired substances which can condition the photocatalytic process, or in which it is pre-treated to reduce the turbidity, which would negatively affect the performance of the reactor. The pre-treatment unit can also serve to measure chemical compounds which are adjuvants of the photocatalytic process, such as hydrogen peroxide, and perform any pH correction.

Downstream of the reactor of the invention a post-treatment unit may be provided, for example comprising microfiltration, nanofiltration or ultrafiltration systems, or also centrifugation systems or other decanting and sedimentation systems; this unit is especially useful in the case of TiO₂/graphenes combination in the form of granules and/or nanoparticles, for recovery and re-use of the same and to avoid this powder being discharged downstream of the plant. If the granules (or nanoparticles) of the combination are recovered efficiently, recirculation can be performed inside the plant for a significant number of treatment cycles.

The pre- and post-treatment units are not necessary for operation of the reactor of the invention. For example, if the liquid entering the reactor is not turbid and does not contain particulate, it is possible to avoid use of the pre-treatment unit; if the liquid coming out of the reactor 10 does not contain particulate, for example when titanium dioxide is used in the form of pellets (separation of which from the liquid is immediate and occurs already inside the reactor 10), the post-treatment unit can be avoided.

The invention will be further illustrated by the following examples.

### Example 1

A test of contaminants removal through electrooxidation from wastewater is carried out according to the invention.

The test is performed in a system like reactor 10 described with reference to FIG. 1, using electrodes having on their surface a nanostructured carbon material with a mass concentration of graphenes of 85% (RECAM® product produced by the Applicant), and adopting the following the main operative parameters:

electrodes surface: 1588 cm²

distance between electrodes: 4 mm

direction of wastewater flow: perpendicular to electrodes

thickness of electrodes: 2 mm

number of holes in each electrode: one

current applied: 45 mA/cm²

voltage: 5.5 Volt

flow rate of electrooxidation cell in continuous mode: 450 litres/hour

residence time into the electrooxidation cell: 5 minutes

configuration of electrodes: bipolar

number of electrodes: 84

The sample treated in the test is a landfill leachate with an initial concentration of COD of 3420 mg/l, a concentration of NH₃ of 1240 mg/l, a chlorine concentration of 2230 mg/l, a conductivity of 12.450 μS/cm² and a pH=7.8. The wastewater is acidified to pH 5.5 with sulphuric acid before to pass through the electrooxidation cell. No other chemicals are added to the wastewater. Samples of wastewater are taken after the electrooxidation process and analyzed. The analysis results are reported in Table 1; in the table, the values of NH₃ and chloride are given as concentration (mg/l) of the chemical; the COD value is given in mg/l; NTU stands for “Nephelometric Turbidity Units”, a standard measure of turbidity of liquids and a key measure of water quality; and the “H₂ developed” value is the volume percentage of hydrogen in the gas produced at the electrodes.

### Example 2

### Comparative

The test of Example 1 is repeated in identical conditions, with the only difference that the electrodes employed are made by MWCNTs provided by Taunit University in Russia. The test results are reported in Table 1.

### Example 3

### Comparative

The test of Example 1 is repeated in identical conditions, with the only difference that the electrodes employed are made by aluminum bought from Metalluminio S.p.A. of Cardano al Campo, Varese (Italy). The test results are reported in Table 1.

TABLE 1

| Measured | | Example 1 | Example 2 | Example 3 |
|---|---|---|---|---|
| parameter | Initial value | (invention) | (comparative) | (comparative) |
| COD (mg/l) | 3420 | 1120 | 1710 | 2450 |
| NH₃ (mg/l) | 1240 | 450 | 650 | 1900 |
| Color (NTU) | 129.4 | 2.3 | 14.5 | 118.6 |
| Chloride (mg/l) | 1310 | 1310 | 1440 | 2180 |
| pH | 5.5 | 5.1 | 5.4 | 7.6 |
| H₂ developed | / | 27% | 9% | 1% |

### Example 4

A test of remediation through electrooxidation of groundwater with a high concentration of nitrates is carried out according to the invention.

The same experimental set-up of Example 1 is used, and the test is carried out with the following the main operative parameters:

electrode surface: 1588 cm²

distance between electrode: 4 mm

direction of wastewater flow: perpendicular to electrodes

thickness of electrodes: 2 mm

number of holes in each electrode: one

current applied: 28 mA/cm²

voltage: 9.5 Volt

flowrate of electrooxidation cell in continuous mode: 300 liters/hour

residence time into the electrooxidation cell: 4.2 minutes

configuration of electrodes: bipolar

number of electrodes: 62

The test is carried out on a groundwater sample with an initial concentration of nitrates of 86 mg/l. No chemicals are added to the groundwater and no acidification is made. At the end of the test, a specimen of treated groundwater is analyzed. The analysis results are reported in Table 2.

### Example 5

### Comparative

The test of Example 4 is repeated in identical conditions, with the only difference that the electrodes employed are made by MWCNTs provided by Taunit University in Russia. The test results are reported in Table 2.

### Example 6

### Comparative

The test of Example 4 is repeated in identical conditions, with the only difference that the electrodes employed are made of iron. The test results are reported in Table 2.

TABLE 2

| Measured | | Example 4 | Example 5 | Example 6 |
|---|---|---|---|---|
| parameter | Initial value | (invention) | (comparative) | (comparative) |
| Nitrate (mg/l) | 86 | 4 | 14 | 81 |

From the data reported in Table 1, it is evident that the graphenes-based electrodes of the invention give the best results in terms of efficiency of the electrooxidation cell. The worst results, obtained in case of electrode made by aluminum, are due to the fact that the residence time it is too short to have a complete reaction and that aluminum electrodes need more DC current to produce interesting results. Also, it is important to note that the volume concentration of H₂ into the gas developed during the electrooxidation process is of 27% in the case of use of the electrodes of the invention, an much lower with prior art electrodes; this is another reason for the different results obtained.

Similarly, the data reported in Table 2 show that the electrooxidation process carried out with electrodes according to the invention (example 4) yields far better results than the same process in which prior art electrodes are used; this is true in particular in comparison with the iron electrodes of example 6, that give rise to an almost insignificant oxidation of nitrates.

From the examples above it is noted the MWCNTs electrodes give better results then in case of iron or aluminum ones, but there is quite a large gap if compared with the graphene-based electrodes of the invention.

The foregoing description of embodiments of the present invention has been presented for the purpose of illustration and description. It is not intended to be exhaustive or to limit the invention to the particular forms disclosed. Obvious modifications and variations are possible in light of the above disclosure without departing from the spirit and scope of the present invention. The embodiments described were chosen to best illustrate the principles of the invention and practical applications thereof to enable one of ordinary skill in the art to utilize the invention in various embodiments and with various modifications as suited to the particular use contemplated. It is intended that the scope of the invention be defined by the claims appended hereto.

1-21. (canceled)

22. An electrode for electrochemical reactions made of graphenes, of a mixture of graphenes and other nanostructured carbon-based materials comprising at least 30% by weight of graphenes, or of a mixture of graphenes and other non-nanostructured carbon-based materials comprising at least 80% by weight of graphenes.

23. The electrode according to claim 22, in which said graphenes comprise the graphene-derivatives graphene-oxides and graphanes.

24. The electrode according to claim 22, in which said nanostructured carbon-based materials are fullerenes, carbon nanotubes, graphite nanoplates, carbon nanofibers or their mixtures.

25. The electrode according to claim 24, in which the contents of graphenes is comprised between about 60% and about 90% by weight.

26. The electrode according to claim 22, in which said non-nanostructured carbon-based materials are expanded graphite or other graphite-based compounds.

27. The electrode according to claim 22, in which said graphenes, mixture of graphenes and other nanostructured carbon-based materials, or mixture of graphenes and other non-nanostructured carbon-based materials, is compressed to form a compact structure.

28. The electrode according to claim 27, in which said mixture of graphenes and other nanostructured carbon-based materials is compressed with pressure higher then 300 kg/cm².

29. An electrooxidation process for the removal of organic and inorganic contaminants from a liquid waste, comprising letting electric current pass between at least an anode and at least a cathode immersed in the liquid to be treated, wherein said anode is an electrode according to claim 22.

30. The electrooxidation process according to claim 29, wherein said anode comprises a mixture of graphene and other carbon-based nanostructured material comprising between about 60% and about 90% by weight of graphene.

31. The electrooxidation process according to claim 29, wherein said electric current has an intensity comprised between 10 and 70 mA/cm² of electrode.

32. The electrooxidation process according to claim 29, wherein a voltage difference comprised between 2 and 15 V is applied between said anode and said cathode.

33. The electrooxidation process according to claim 29, wherein a salt is added to said liquid waste to adjust the conductivity of the liquid.

34. The electrooxidation process according to claim 33, wherein said salt is sodium chloride or sodium sulfate.

35. The electrooxidation process according to claim 29, wherein the pH of the liquid to be treated is adjusted by adding an acid or a basic compound.

36. The electrooxidation process according to claim 35 wherein, when the liquid contains relevant amounts of oxidable substances, said addition makes the liquid pH acid.

37. The electrooxidation process according to claim 35 wherein, when the liquid contains hydrocarbons, said addition makes the liquid pH basic.

38. The electrooxidation process according to claim 29, wherein a magnetic field is applied to the liquid to be treated.

39. The electrooxidation process according to claim 29, further comprising the treatment of said liquid waste by means of photocatalytic oxidation of at least one of said contaminants in the presence of photocatalyst material consisting of a combination of rutile and/or anatase and graphenes in contact with each other.

40. The electrooxidation process according to claim 39, wherein said photocatalytic oxidation treatment occurs at the same time as said electrooxidation process.

41. The electrooxidation process according to claim 39, wherein said photocatalytic oxidation treatment takes place downstream of said electrooxidation process.

42. The electrode for electrochemical reactions according to claim 22, wherein said electrochemical reactions take place in galvanic processes, Dye-Sensitized Solar Cells (DSSCs), electroflotation for wastewater treatment, or production and storage of energy in batteries and fuel cells.

43. An electrooxidation reactor for carrying out the process of claim 29, comprising at least an anode and at least a cathode immersed in the liquid to be treated, wherein said anode is an electrode according to claim 22.

44. The electrooxidation reactor according to claim 43 provided with pipes, pumps and valves to control the incoming flow of liquid to be treated, comprising at least one tank, in the form of a cell, said cell containing at least one anode and one cathode powered in direct current by a current rectifier that powers said anode and said cathode via bars of conducting material, and provided with at least one vent system and an inlet for positioning multiparametric probes in the reacting liquid.

45. The electrooxidation reactor according to claim 44, further comprising an aeration and oxygenation system for introducing in the reactor of micro- or nano-bubbles of air of oxygen.

46. The electrooxidation reactor according to claim 45, wherein said aeration and oxygenation system is a chamber with microslits positioned on the bottom of said cell, fed with oxygen entering the chamber from a dedicated pipe.
